(19) United States
(12) Patent Application Publication
(10) Pub. No.: US 2013/0044901 A1
(43) Pub. Date: Feb. 21, 2013

(54) MICROPHONE ARRAYS AND MICROPHONE ARRAY ESTABLISHING METHODS

(71) Applicants: Ping Dong, Cupertino, CA (US); Qing-Guang Liu, Sunnyvale, CA (US); Wan-Chieh Pai, Taipei City (TW)

(72) Inventors: Ping Dong, Cupertino, CA (US); Qing-Guang Liu, Sunnyvale, CA (US); Wan-Chieh Pai, Taipei City (TW)

(73) Assignee: FORTEMEDIA, INC., Sunnyvale, CA (US)

(21) Appl. No.: 13/210,817

(22) Filed: Aug. 16, 2011

(51) Int. Cl. H04R 3/00

(52) U.S. Cl. 381/122

(57) ABSTRACT

A microphone array is provided. The microphone array is disposed on an electrical device, and includes: at least one built-in microphone, being built in the electrical device, having a first frequency spectrum; and an audio processor, coupled to the built-in microphone, for coupling to an external transducer, including: a spectrum estimation unit for estimating a second frequency spectrum of the external transducer.

### BACKGROUND OF THE INVENTION

1. Field of the Invention

The present invention relates generally to acoustic signal processing techniques, and more specifically to acoustic signal processing techniques in establishing a microphone array.

2. Description of the Related Art

An audio apparatus such as a sound recording device or a voice communication device, for example, disposed in a mobile phone, personal digital assistant (PDA), laptop (also known as a notebook), tablet personal computer (tablet PC), or All-in-One computer, usually has only one microphone for receiving acoustic signals due to cost-cutting or since it is enough for common users in applications where high quality is not necessary.

However, users still prefer clear and true sounds and voices. Thus, it is desirable to provide an apparatus or method for enhancing the sound/voice quality of the said audio apparatus which has only one microphone.

### BRIEF SUMMARY OF THE INVENTION

A detailed description is given in the following embodiments with reference to the accompanying drawings.

The present invention provides a microphone array. The microphone array is disposed on an electrical device, and comprises: at least one built-in microphone, being built in the electrical device, having a first frequency spectrum; and an audio processor, coupled to the built-in microphone, for coupling to an external transducer, comprising: a spectrum estimation unit for estimating a second frequency spectrum of the external transducer.

The present invention also provides a microphone array establishing method. The method is used for establishing a microphone array on an electrical device having at least one built-in microphone having a first frequency spectrum, comprising: plugging an external transducer into the electrical device; estimating a second frequency spectrum of the external transducer; and compensating for the differences between the first and second frequency spectrum.

### BRIEF DESCRIPTION OF THE DRAWINGS

The present invention can be more fully understood by reading the subsequent detailed description and examples with references made to the accompanying drawings, wherein:

FIG. 1A shows a mobile phone using the microphone array of the present invention;

FIG. 1B is a schematic diagram of the microphone array of the present invention;

FIG. 2 shows the audio processor of the present invention; and

FIG. 3 shows a flowchart of the microphone array establishing method of the present invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

In order to reproduce better quality sound/voice, a microphone array is sometimes used in the audio apparatus such as a sound recording device or a voice communication device (for example, disposed in a mobile phone, PDA, laptop, tablet PC, or All-in-One computer). The microphone array usually includes one main microphone (transducer) disposed close to a voice source for receiving as much voice sound as possible and one reference microphone (another transducer) disposed far away from the voice source for mainly receiving ambient noises. Through the main microphone and the reference microphone, ambient noises can be easily removed from the voices and the original voice output from the voice source can be correctly reproduced. However, the main microphone and the reference microphone have to be manufactured to have the same or matching frequency spectrums (a frequency spectrum plots the microphone sensitivity, i.e., transduction gain, in decibels over a range of frequencies).

The present invention is provided to be used in an audio apparatus which, in most cases, has only one microphone, and the purpose of the present invention is to establish a microphone array by integrating only one microphone (built-in microphone) of the audio apparatus with another external transducer such as another microphone. It should be noted that a microphone array may have more than two microphones, and the present invention may be used in the audio apparatus which has more than only one microphone.

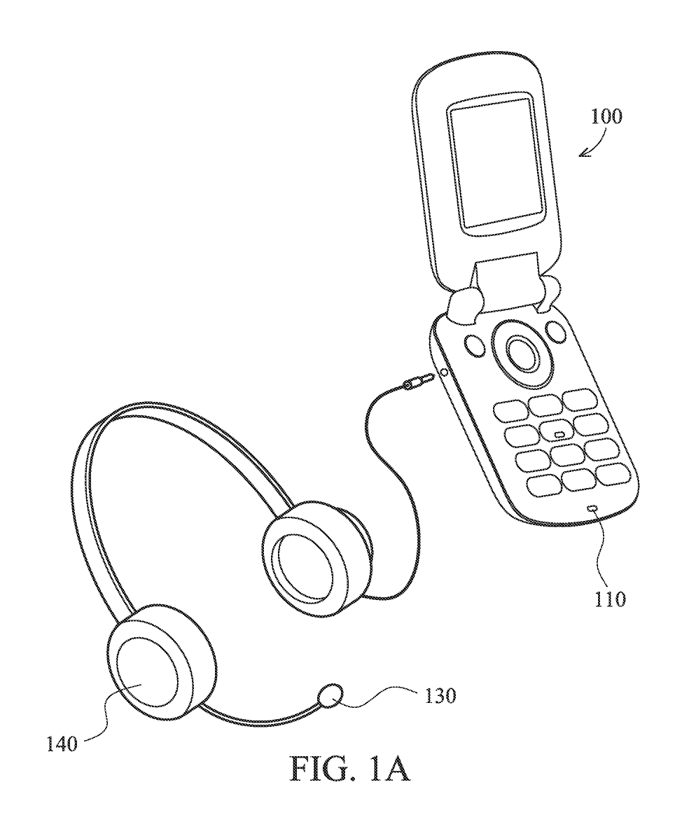

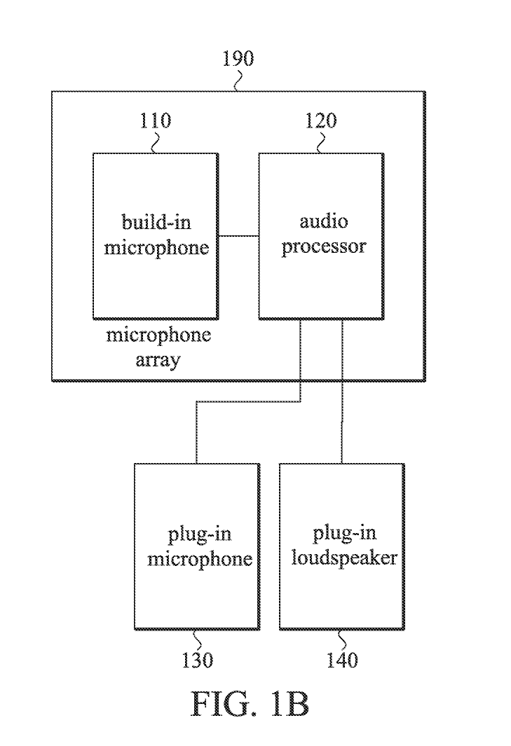

FIG. 1A shows a mobile phone using the microphone array of the present invention, and FIG. 1B is a schematic diagram of the microphone array of the present invention. It should be noted that although the microphone array 190 of the present invention in this embodiment is disposed in a mobile phone 100, the present invention should not be limited thereto. In other embodiments, the microphone array of the present invention may be disposed in any other electrical device such as a PDA, laptop, tablet PC, or the All-in-One computer.

The microphone array 100 of the present invention comprises at least one built-in microphone 110, which is built into the mobile phone 100, and an audio processor 120, which is coupled to the built-in microphone 110. The microphone array 190 is established based on the built-in microphone 110 and a plugged-in microphone 130 (an external transducer) which is plugged into the mobile phone 100. In this case, the built-in microphone 110 can be used as the main microphone of the microphone array 190, while the plugged-in microphone 130 can be used as the reference microphone of the microphone array 190. Since the built-in microphone 110 and the plugged-in microphone 130 may probably be manufactured by different manufacturers which adhere to different microphone specifications, they may probably have different frequency responses (frequency spectrum) to the same sound inputs. For example, in an embodiment (which will be discussed later), the built-in microphone 110 has a first frequency spectrum which has a higher sensitivity (i.e., transduction gain) to the 0-10 KHz frequency band and a lower sensitivity to the 10-20 kHz frequency band, then the plugged-in microphone 130, which has a second frequency spectrum which has a lower sensitivity to the 0-10 KHz frequency band and a higher sensitivity to the 10-20 kHz frequency band. The difference between the frequency spectrums of the microphones 110 and 130 is not good for audio signal processing. Thus, the present invention provides an audio processor 120 to overcome this difference.

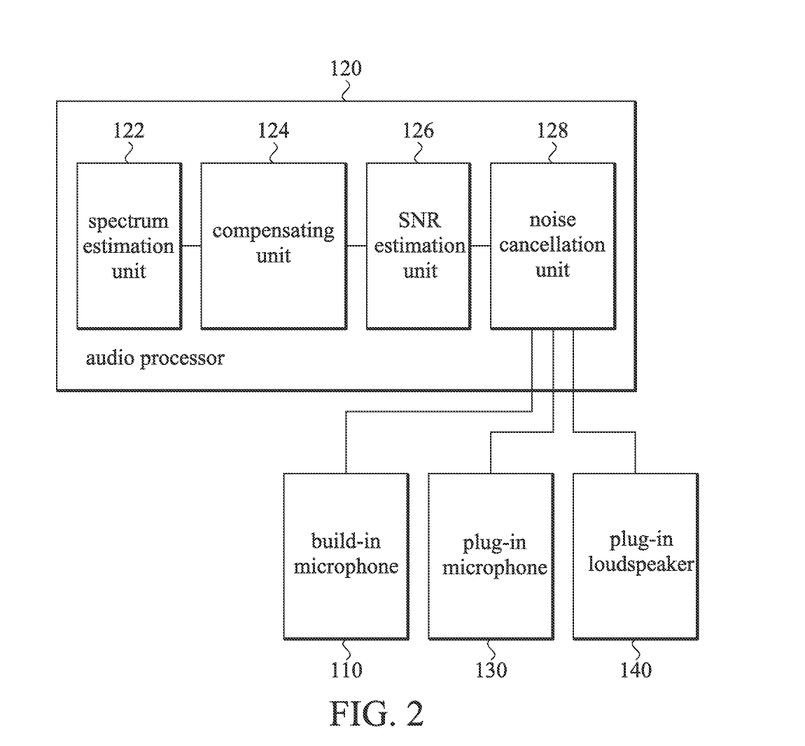

FIG. 2 shows the audio processor 120 of the present invention. The audio processor 120 of the present invention comprises a spectrum estimation unit 122, a compensating unit 124, a signal-to-noise ratio (SNR) estimation unit 126 and a noise cancellation unit 128.

The spectrum estimation unit 122 of the present invention is mainly used to estimate the frequency spectrum of the plugged-in microphone 130. As to the frequency spectrum of the built-in microphone 110, it may be estimated by the spectrum estimation unit 122 in accordance with an embodiment of the invention, or recorded in a memory (not shown) either separated from or integrated with the audio processor 120.

As shown in FIG. 2, the compensating unit 124 of the audio processor 120 is coupled to the frequency spectrum estimating unit 122. The compensating unit 124 of the present invention is used to compensate for the difference between the first and second frequency spectrum. In the embodiment in which the built-in microphone 110 and the plugged-in microphone 130 have different sensitivities (the built-in microphone 110 has a first frequency spectrum which has a higher sensitivity to the 0-10 KHz frequency band and a lower sensitivity to the 10-20 kHz frequency band, and the plugged-in microphone 130 has a second frequency spectrum which has a lower sensitivity to the 0-10 KHz frequency band and a higher sensitivity to the 10-20 kHz frequency band), the compensating unit 124 may uniform or equalize the sensitivity of the microphones 110 and 130 in the same frequency band, for example, by decreasing the sensitivity in the 0-10 kHz frequency band of the built-in microphone 110 to that of the plugged-in microphone 130 and by decreasing the sensitivity in the 10-20 kHz frequency band of the plugged-in microphone 130 to that of the built-in microphone 110.

After the compensations for frequency spectrums of the microphones 110 and 130 are completed, the microphone array 190 may be suitably established. Then, the signal-to-noise ratio (SNR) estimation unit 126, which is coupled to the compensating unit 124, may derive an SNR estimate from the sounds received from the built-in microphone 110 and the plugged-in microphone 130 based on the compensated first and second frequency spectrums. Following, the noise cancellation unit 128, which is coupled to the SNR estimation unit 126, would further cancel ambient noise from the sounds based on the SNR estimate.

With the microphone array 190 of the present invention which is established based on the built-in microphone 110 and the plugged-in microphone 130, ambient noise can be easily removed and electrical signals for high fidelity original sounds can be correctly produced.

In another embodiment, the microphone array 190 of the present invention can be established based on the built-in microphone 110 and another external transducer such as a plugged-in loudspeaker 140 as shown in FIG. 1A. The loudspeaker 140, an external transducer which converts an electrical signal into sound waves, is the functional opposite of a microphone, and can actually work “in reverse” to a microphone. However, the loudspeaker as a microphone usually works with limited frequency response. In this case, the built-in microphone 110 can be used as the main microphone of the microphone array 190, while the plugged-in loudspeaker 140 can be used as the reference microphone of the microphone array 190. Through the spectrum estimation unit 122 and the compensating unit 124 of the present invention, the frequency spectrum of the plugged-in loudspeaker 140 can be estimated, and the difference between the frequency spectrums of the built-in microphone 110 and the plugged-in loudspeaker 140 can be compensated for. Through the SNR estimation unit 126 and the compensating unit 128 of the present invention, the SNR estimate can be derived from the sounds received by the built-in microphone 110 and the plugged-in loudspeaker 140 based on the compensated frequency spectrums, and ambient noise can be cancelled from the sounds based on the SNR estimate and electrical signals for reproducing high fidelity original sounds.

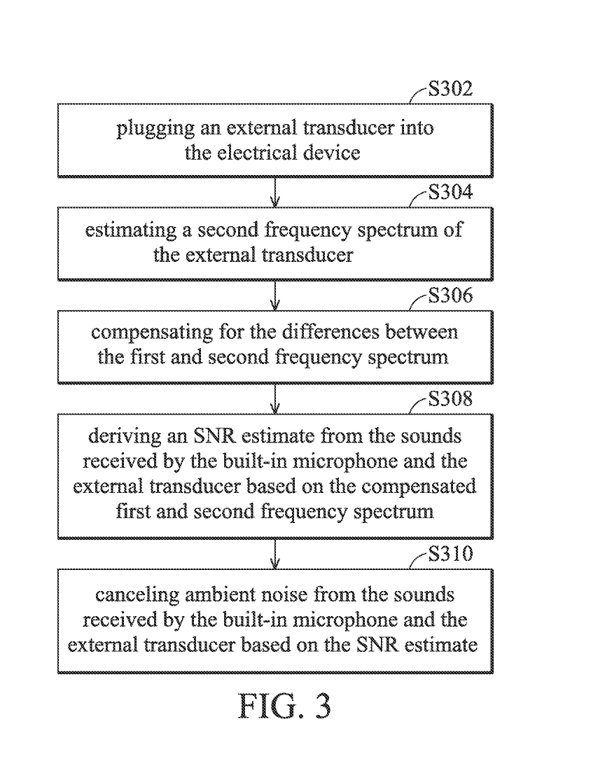

In addition to the microphone array 190, the present invention further provides a microphone array establishing method. FIG. 3 shows a flowchart of the microphone array establishing method of the present invention. The microphone array establishing method is used to establish a microphone array on an electrical device, such as a mobile phone, PDA, laptop, tablet PC, or All-in-One computer, which has at least one built-in microphone, for example, the built-in microphone 110 as shown in FIG. 1A, having a first frequency spectrum. In one embodiment, the method of the present invention comprises: in step S302, plugging an external transducer, for example, the plugged-in microphone 130 or the plugged-in loudspeaker 140 as shown in FIG. 1A, into the electrical device; in step S304, estimating a second frequency spectrum of the external transducer; and in step S306, compensating for the differences between the first and second frequency spectrum. In some embodiments, the method of the present invention further comprises: in step S308, deriving an SNR estimate from the sounds received by the built-in microphone 110 and the external transducer based on the compensated first and second frequency spectrum; and in step S310, canceling ambient noise from the sounds received by the built-in microphone 110 and the external transducer based on the SNR estimate. Since the microphone array establishing method of the present invention, which is used to establish the microphone array 190, has been fully described in the previous embodiments, the method, for brevity, will not be further discussed.

Although only one plugged-in microphone 130 or plugged-in loudspeaker 140 is used and discussed in each previous embodiment, the number of the external transducers used to establish a microphone array in the present invention should not be limited thereto. For example, a microphone array can be established by integrating the built-in microphone 110, the plugged-in microphone 130 and the plugged-in loudspeaker 140. While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A microphone array, disposed on an electrical device, comprising:
at least one built-in microphone, being built in the electrical device, having a first frequency spectrum; and
an audio processor, coupled to the built-in microphone, for coupling to an external transducer, comprising:
a spectrum estimation unit for estimating a second frequency spectrum of the external transducer.

2. The microphone array as claimed in claim 1, wherein the audio processor further comprises a compensating unit, coupled to the frequency spectrum estimating unit, for compensating for the differences between the first and second frequency spectrum.

3. The microphone array as claimed in claim 2, wherein the audio processor further comprises a signal-to-noise ratio (SNR) estimation unit, coupled to the compensating unit, for deriving an SNR estimate from the sounds received by the built-in microphone and the external transducer based on the compensated first and second frequency spectrums.

4. The microphone array as claimed in claim 3, wherein the audio processor further comprises a noise cancellation unit, coupled to the SNR estimation unit, for canceling ambient noise from the sounds received by the built-in microphone and the external transducer based on the SNR estimate.

5. The microphone array as claimed in claim 1, wherein the external transducer is a plugged-in microphone, plugged into the electrical device.

6. The microphone array as claimed in claim 1, wherein the external transducer is a plugged-in loudspeaker used as a makeshift microphone.

7. A microphone array establishing method, for establishing a microphone array on an electrical device having at least one built-in microphone having a first frequency spectrum, comprising:
plugging an external transducer into the electrical device;
estimating a second frequency spectrum of the external transducer; and
compensating for the differences between the first and second frequency spectrum.

8. The microphone array establishing method as claimed in claim 7, further comprising deriving an SNR estimate from the sounds received by the built-in microphone and the external transducer based on the compensated first and second frequency spectrum.

9. The microphone array establishing method as claimed in claim 7, further comprising canceling ambient noise from the sounds received by the built-in microphone and the external transducer based on the SNR estimate.
